(19) United States
(12) Patent Application Publication
(10) Pub. No.: US 2009/0308264 A1
(43) Pub. Date: Dec. 17, 2009

(54) ULTIMATE COMBO SMOKER

(76) Inventors: GARY LEE ESTESS, Von Ormy, TX (US); Russell Earl Walker, San Antonio, TX (US)

Correspondence Address: GARY LEE ESTESS, 4320 NOYES RD, VON ORMY, TX, 78073, US

(21) Appl. No.: 12/138,354

(22) Filed: Jun. 12, 2008

(51) Int. Cl. A23B 4/044

(52) U.S. Cl. 99/482

(57) ABSTRACT

A 3 piece universal tray set placed directly on top of your grill (gas, electric, or any type grill you'd like to use. This tray provides you ability to use any type wood to smoke your food, while evenly distributing the heat and smoke.

The bottom (ash) tray holds your wood chips. This tray also catches your ashes preventing your pit/grill from rusting.

The lid tray has holes in it letting the smoke rise and heat or cook your food also catches grease preventing fire.

Cooking grill is what your food is placed on to cook your food without drying and or burning your food.

### CROSS REFERENCE

U.S. Pat. No. 6,874,496—Combination smoker and barbecue pit
Inventors: Waits; Gregory A. (San Antonio, Tex.), Waits; Christopher M. (Cypress, Tex.)
Appl. No.: Ser. No. 10/465,275
Filed: Jun. 19, 2003
   U.S. Pat. No. 6,102,028—Smoker attachment for a barbecue grill
Inventors: Schlosser; Erich J. (Barrington, Ill.), Schlosser; Edna (Barrington, Ill.),
Stephen; Robert T. (Barrington, Ill.)
Assignee: Weber-Stephen Products Co. (Palatine, Ill.)
Appl. No.: Ser. No. 09/372,703
Filed: Aug. 11, 1999

U.S. Pat. No. 6,701,829—Rapid anti-flare-up smoker for grills
Inventors: Farrow; Samuel (Hartford, Wis.)
Appl. No.: Ser. No. 10/151,756
Filed: May 20, 2002

### BACKGROUND OF INVENTION

1. Field of the Invention

The present invention relates to a compact universal smoker grill that evenly distributes heat and smoke and catches the grease.

2. Description of Related Art

When smoking your food it is generally a good way of naturally flavoring your food with minimum use of wood and pairing your woods for flavoring.

We can take our cast iron chip holder turn it upside making it usable for cooking eggs, beacon, pancakes, etc. . . .

Therefore, invention U.S. Pat. No. 6,874,496 is your traditional smoker. It is very bulky to use and can only be used independently, and very slow cooking, not versatile can only be used as a smoker. This smoker will either be gas, electric, or wood. Mine can be used on whatever grill you have on hand to convert it to a smoker.

The closest related inventions would be U.S. Pat. No. 6,701,829 and U.S. Pat. No. 6,102,028. The draw-backs to these inventions compared to ours are that they do drop ashes on to your grill causing rot. They do not have a grease catcher, ours does.

Thus the flame and heat drawn thru the updraft of the perforated holes causes the wood to burn too fast. Our grill doesn't have perforated holes on the bottom grill, so naturally it slows the updraft making the wood burn slower for better flavor.

### BRIEF SUMMARY OF INVENTION

With the aftermentioned in mind, this invention eliminates the shortcomings in the prior art of smokers and pits providing that (FIG. 1) it keeps the ashes in the tray so they don't fall into grill and it can also be placed upside down for cooking eggs, beacon, pancakes, etc. . . . , it also catches the grease so you don't have grease fires. (Number 2 of FIG. 2) also catches the grease in the grease rim and (FIG. 2) can be turned upside down for vegetables and or meats of your choice to be cooked or warmed. The grill puts out even heat with a concentrated smoke for a juicier tasting product and does not dry your food out like all other pits.

### BRIEF DESCRIPTION OF SEVERAL VIEWS OF DRAWING

FIG. 1 is the reversible tray for grilling and or holding the woodchips for even distribution. It can be made of all types of metal including cast iron and stainless.

FIG. 2 is the top view of the middle tray for smoke distribution with the perforated holes in it.

FIG. 3 is the top view of the grill to hold the meat that is placed on FIG. 2.

FIG. 4 is a side view of the complete unit together.

### DETAILED DESCRIPTION OF INVENTION

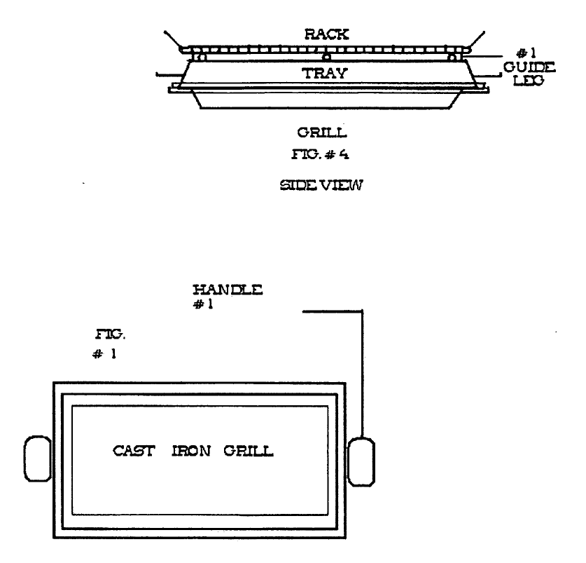

FIG. 1 is the top view of the bottom wood chip tray. Right side up is to burn wood chips, turned upside down is to cook eggs, beacon, pancakes, etc. . . .

FIG. 1 # 1 is the handles to lift apparatus.

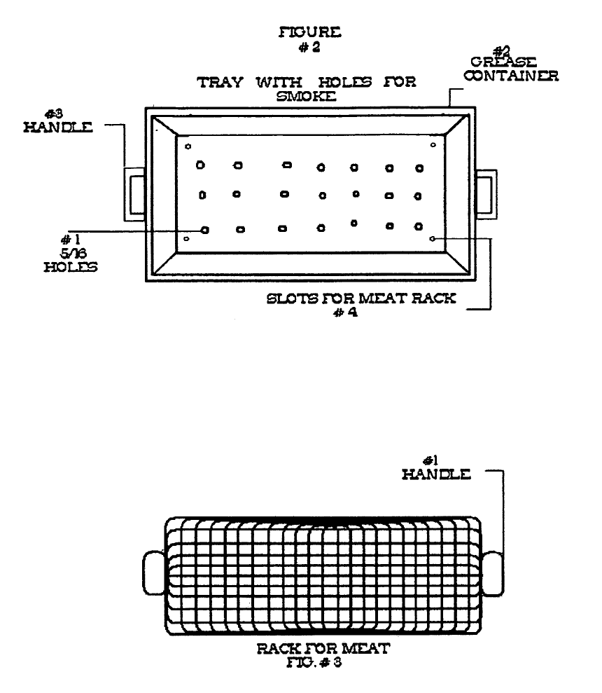

FIG. 2 is wood chip cover 2″ tall and can be different dimensions for different size pits. It is to distribute heat and smoke evenly through perforated holes.

FIG. 2 # 1 is 5/16″ perforated holes to allow even distribution of smoke.

FIG. 2 # 2 is a grease catching rim all around perimeter and is ½″ tall and ½ ″ wide. It can also be turned upside down for steaming, smoking vegetables and or warming foods.

FIG. 2 # 3 is the handle to lift tray.

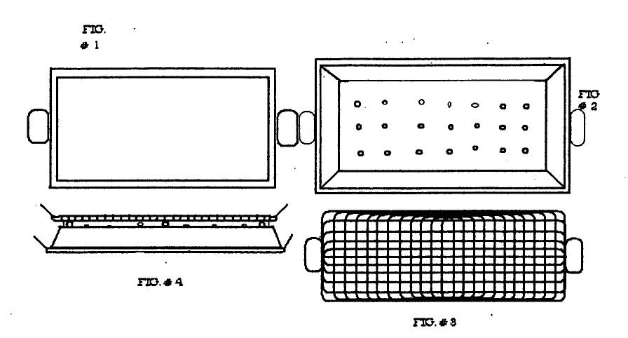

FIG. 2 # 4 is the slots to securely hold the grilling rack FIG. 3.

FIG. 3 is the grilling rack securely mounted onto FIG. 2 into slots FIG. 2 #4 for the food to be cooked.

FIG. 3 # 1 is the handles for securely lifting the grilling rack.

FIG. 4 is the side view of the whole unit together.

FIG. 4 # 1 are the legs that secure onto FIG. 2 # 4.

What is claimed:

1. (canceled)

2. (canceled)

3. (canceled)

4. (canceled)

5. (canceled)

6. (canceled)

7. (canceled)

8. (canceled)

9. (canceled)

10. (canceled)

11. It is a metal smoker tray designed to go into the said grill and or pit (can not be used alone it is designed to go into or on an existing grill of any kind), this grill will therein burn the chips in our tray, the heat and the smoke is distributed evenly under and through the said top tray with perforated holes spaced at even intervals so the heat is distributed uniformly through the meat rack, it can be used in said gas grill, electric grill, open wood grill, an open camping gas stove or home stove of any kind with a vent hood; when you cover the bottom grill with the top tray you are creating the combustion chamber allowing the wood to smolder for a more economical and long lasting smoke for penetration to and through your meat; the top tray or said lid of the combustion chamber works as a funnel to concentrate the smoke through the perforated holes.

12. The meat rack is made to securely fit on the top tray or said lid therefore absorbing maximum heat and smoke flavor; the bottom grill of the combustion chamber can be used independently upside down for grilling eggs, beacon, pancakes, etc. . . . the upper tray of the combustion chamber can also be used independently as a vegetable cooker, food warmer, or food transport tray.

13. We claim that this device can be used even after the fuel source is turned off to heat and smoke for at least 30 minutes more, making it more economical; an extra meat rack can be used to hold your food in place for flipping without loosing any food; and that every part interlocks for stability and comes in numerous sizes and various metals; this invention can be used as in all our claims above 11-13 and can actually be built in (manufactured) into the gas, electric, or conventional wood burning grills.
